(19) United States
(12) Patent Application Publication
(10) Pub. No.: US 2026/0101866 A1
(43) Pub. Date: Apr. 16, 2026

(54) Pet Booster Seat Device

(71) Applicant: Kristi Plaskett, Fremont, CA (US)

(72) Inventor: Kristi Plaskett, Fremont, CA (US)

(21) Appl. No.: 19/316,128

(22) Filed: Sep. 2, 2025

Related U.S. Application Data
(60) Provisional application No. 63/705,558, filed on Oct. 10, 2024.

(51) Int. Cl. A01K 1/035

(52) U.S. Cl. CPC A01K 1/0353

(57) ABSTRACT

A pet booster seat device is disclosed, which is a small booster seat specifically designed for pets to sit on chairs, stools, benches, etc. The pet booster seat device comprises a base component that is configured in a rectangular shape. The base component includes a bottom surface and four sides with built-in rods and connectors to hold the structure upright during use. The base component further includes hooks under the bottom surface which unfold and hook to the bottom of a chair, and a built-in strap at the back to secure to a back of the chair. Further, the base component includes a leash lead built-in and zippered pockets to store items. Finally, the device may also comprise handles, anchors and detachable straps.

### CROSS-REFERENCE TO RELATED APPLICATION

The present application claims priority to, and the benefit of, U.S. Provisional Application No. 63/705,558, which was filed on Oct. 10, 2024, and is incorporated herein by reference in its entirety.

### FIELD OF THE INVENTION

The present invention relates generally to the field of pet booster seat devices. More specifically, the present invention relates to a booster seat for small animals, elevating pets to table height when seated in stationary chairs, highchairs, barstools, benches, etc. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pet booster seat devices. Generally, pet owners may bring their pets with them to mealtimes, events, and other social gatherings. However, constantly supporting an animal on one's lap can be uncomfortable, exhausting and physically taxing. Further, pets being excluded from activities can cause anxiety for owners and the pet.

Additionally, if pets are brought to mealtimes and other social gatherings, they are typically limited to only floor surfaces when with their owners. Further, if secured on a leash, pets may get themselves accidentally wrapped around table and chair legs, creating a safety hazard. Additionally, pets on the floor surface can get stepped on or trip people. Further, people may wish to supervise their pets without having to bend down and look under the table.

Accordingly, there is a demand for an improved pet booster seat device that elevates pets to table height when seated in stationary chairs and benches. More particularly, there is a demand for a pet booster seat device that allows pet owners to keep their pets close and engage with friends and family in a safe and secure manner.

Therefore, there exists a long-felt need in the art for a pet booster seat device that provides users with a booster seat for small animals, elevating pets to table height when seated in stationary chairs, highchairs, barstools, benches, etc. There is also a long-felt need in the art for a pet booster seat device that allows pet owners to keep their pets close and engage with friends and family in a safe and secure manner. Further, there is a long-felt need in the art for a pet booster seat device that features side walls and a mesh top attachment that keep a pet enclosed within the seat on top of comfortable padded cushions. Moreover, there is a long-felt need in the art for a device that includes optional items to add for convenience or aesthetics like water bowls, harnesses, personalized text or logos, different materials, cushion comforts, etc. Further, there is a long-felt need in the art for a pet booster seat device that offers a way for pet owners to keep their pets part of a group when at different social gatherings. Finally, there is a long-felt need in the art for a pet booster seat device that is foldable for storage and transport.

The subject matter disclosed and claimed herein, in one embodiment thereof, comprises a pet booster seat device. The device is a small booster seat specifically designed for pets to sit on chairs, stools, benches, etc. The pet booster seat device comprises a base component that is configured in any shape, rectangular, square, etc., depending on size. The base component includes a bottom surface and four sides with built-in rods and connectors to hold the structure upright during use. The base component further includes hooks under the bottom surface which unfold and hook to the bottom of a chair, and a built-in strap at the back to secure to a back of the chair. Further, the base component includes an adjustable leash lead built-in and zippered pockets to store items. The front wall has different levels of adjustment that may be raised and lowered.

In this manner, the pet booster seat device of the present invention accomplishes all of the foregoing objectives and provides users with a booster seat for small animals. The device is a booster seat that features side walls and a mesh top to keep a pet enclosed within the seat. The device can be folded up when not in use. The top can also be a telescoping mechanism that is built into the device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet booster seat device. The pet booster seat device comprises a base component that includes a bottom surface and four sides with built-in rods and connectors to hold the structure upright during use. The base component further includes hooks under the bottom surface which unfold and hook to the bottom of a chair, and a built-in strap at the back to secure to a back of the chair.

In one embodiment, the pet booster seat device provides users with a booster seat for small animals, such as pets. The device allows pet owners to keep their pets close and engage with friends and family in a safe and secure manner. The pet booster seat device is specifically designed for pets to sit on stationary chairs, highchairs, barstools, benches, etc. Accordingly, the device offers a way for pet owners to keep their pets elevated, such that they can become part of a group when at different social gatherings.

In one embodiment, the pet booster seat device comprises a base component that is configured in a rectangular shape or any other suitable shape as is known in the art. The base component includes a bottom surface and four sides which collapse down flat for storage. Then when in use, the four sides are extended up to form a box-like structure with an open interior cavity for retaining the small pet. Typically, the bottom surface and four sides include built-in lightweight rods and connectors along the edges to hold the structure upright during use. Specifically, the rods and connectors would be positioned on the bottom, back, side, and corner edges of the four sides and act to secure the four sides to the bottom surface and also allow the four sides to fold flat onto the bottom surface and extend up, as needed. Typically, the bottom surface and four sides would comprise a thin material that is sturdy and lightweight, and these rods and connectors would attach to the thin material, pulling it taut to form the shape of the pet booster seat device.

In one embodiment, the base component comprises a mesh top attachment that is secured to the top of the four sides, completely enclosing the pet within the open cavity of the device. The mesh top attachment can be secured to the four sides via hook and loop fasteners, snaps, zippers, adhesives, etc., or any other suitable securing means as is known in the art. The mesh top attachment protects the pet, retains it within the device, and allows it to view its surroundings. Thus, the mesh top attachment keeps a pet enclosed within the device on top of comfortable padded cushions positioned on the bottom surface during use.

In one embodiment, the interior surface of the sides and bottom surface comprises cushions or a cushioning layer. Overtop the cushioning layer is a cover layer made of a sturdy, flexible, waterproof material which protects the sides and bottom surfaces and is able to be wiped clean, as needed. Further, the side cushions or cushioning layer will be thinner than the bottom surface cushions/cushioning layer, so that it remains foldable for storage and transport.

In one embodiment, the front side wall would be lower than the other three side walls during use. Typically, the front side wall can be adjusted, such that it is lowered down or raised up to be level with the other side walls. The front side wall can be adjusted up or down via a telescoping mechanism or being folded up or down, etc., or any other suitable adjusting means as is known in the art.

In one embodiment, the base component comprises various straps with adjustable lengths and styles to attach to the different types of chairs, benches, or stools. The straps are typically secured to anchor points on the base component. Specifically, the bottom of the base component, which contacts a chair or stool surface, would comprise an anchor point at each corner of the base component. Further, the base component can also comprise an anchor point at each side of the base component also or instead of the anchor points at each corner. The straps secure to the anchor points, then wrap around the seat of the chair or stool and attach together, securing the device to a top of the chair or stool seat for use.

In one embodiment, the pet booster seat device may vary in size, fabric, and design, depending on the type of chair or stool that it is to be secured to and/or depending on a user's wants and/or needs.

In one embodiment, the base component further includes hooks under the bottom of the base component. The hooks would be secured to an outside edge of the base component and unfold and hook to an outside edge of a chair seat during use. Typically, the hooks fold back against the bottom of the base component with a spring bracket when not in use.

In another embodiment, in addition to these hooks, there is non-slip material positioned on the bottom of the base component to prevent movement of the device when secured to a chair or stool, to further keep the pet secured and safe during use.

In one embodiment, the outside of the back wall or the outside of the back of the base component has a built-in snap strap which secures to a back of the chair or stool. This snap strap, which is detachable, would also double as a carrying strap, and a user can place it over their shoulder when the device is folded up for transport. Alternatively or additionally, there could be a carrying handle strap in the front or back of the base component made with thick and durable material for carrying the device during transport.

In one embodiment, at least one of the interior sides of the base component comprises a leash lead built-into the inside. The leash lead includes a leash hook to allow a user to hook to a harness or collar of the pet. The leash lead acts to further secure the pet within the device during use and prevent injury.

In one embodiment, the base component comprises zippered pockets, one on either side of the base component. The zippered pockets are used to store items, such as treats, supplies, and other pet-related items. The zippered pockets can be secured via zippers, hook and loop fasteners, snaps, etc. The zippered pockets can be any suitable shape and size as is known in the art.

In one embodiment, there is one or two zippers (or other fastening means) positioned around a bottom and/or sides of the base component for removing and washing the cover, as needed.

In one embodiment, the base component (i.e., bottom surface and four sides) would be foldable when not in use. Thus, the device can be compacted down and stored behind or under furniture or can easily be transported in its compacted position when users are traveling and/or going on outings.

In one embodiment, optional items can be added to the device for added convenience or aesthetics, such as, but not limited to, water bowls, harnesses, personalized text or logos, etc. Further, the base component can be made of different materials, cushion comforts, designs, patterns, colors, etc.

In one embodiment, the pet booster seat device is manufactured from plastics, vinyl, PVC, polyethylene, polystyrene, etc., or other suitable materials as is known in the art, or a combination of such materials.

In yet another embodiment, the pet booster seat device comprises a plurality of indicia.

In yet another embodiment, a method of securing a pet on a stationary chair is disclosed. The method includes the steps of providing a pet booster seat device comprising a base component with a bottom surface and four sides. The method also comprises securing the base component to a stationary chair via a strap and hooks. Further, the method comprises extending the sides to form an open cavity for retaining the pet. The method also comprises positioning a pet within the open cavity and securing the pet with a leash lead. Finally, the method comprises attaching the mesh top attachment to keep the pet enclosed within the device during use.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the pet booster seat device of the present invention in accordance with the disclosed architecture;

FIG. 2 illustrates a perspective view of one embodiment of the pet booster seat device of the present invention showing the sides extended for use in accordance with the disclosed architecture;

FIG. 3 illustrates a perspective view of one embodiment of the pet booster seat device of the present invention showing the front wall lowered all the way down in accordance with the disclosed architecture;

FIG. 4 illustrates a perspective view of one embodiment of the pet booster seat device of the present invention showing the mesh attachment secured to the base component in accordance with the disclosed architecture;

FIG. 5 illustrates a perspective view of one embodiment of the pet booster seat device of the present invention showing the device in use in accordance with the disclosed architecture; and

FIG. 6 illustrates a flowchart showing the method of securing a pet on a stationary chair in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pet booster seat device that provides users with a booster seat for small animals, elevating pets to table height when seated in stationary chairs, highchairs, barstools, benches, etc. There is also a long-felt need in the art for a pet booster seat device that allows pet owners to keep their pets close and engage with friends and family in a safe and secure manner. Further, there is a long-felt need in the art for a pet booster seat device that features side walls and a mesh top attachment that keep a pet enclosed within the seat on top of comfortable padded cushions. Moreover, there is a long-felt need in the art for a device that includes optional items to add for convenience or aesthetics like water bowls, harnesses, personalized text or logos, different materials, cushion comforts, etc. Further, there is a long-felt need in the art for a pet booster seat device that offers a way for pet owners to keep their pets part of a group when at different social gatherings. Finally, there is a long-felt need in the art for a pet booster seat device that is foldable for storage and transport.

The present invention, in one exemplary embodiment, is a novel pet booster seat device. The pet booster seat device comprises a base component that is configured in a rectangular shape. The base component includes a bottom surface and four sides with built-in rods and connectors to hold the structure upright during use. The base component further includes hooks under the bottom surface which unfold and hook to the bottom of a chair, and a built-in strap at the back to secure to a back of the chair. Further, the base component includes a leash lead built-in and zippered pockets to store items. The present invention also includes a novel method of securing a pet on a stationary chair. The method includes the steps of providing a pet booster seat device comprising a base component with a bottom surface and four sides. The method also comprises securing the base component to a stationary chair via a strap and hooks. Further, the method comprises extending the sides to form an open cavity for retaining the pet. The method also comprises positioning a pet within the open cavity and securing the pet with a leash lead. Finally, the method comprises attaching the mesh top attachment to keep the pet enclosed within the device during use.

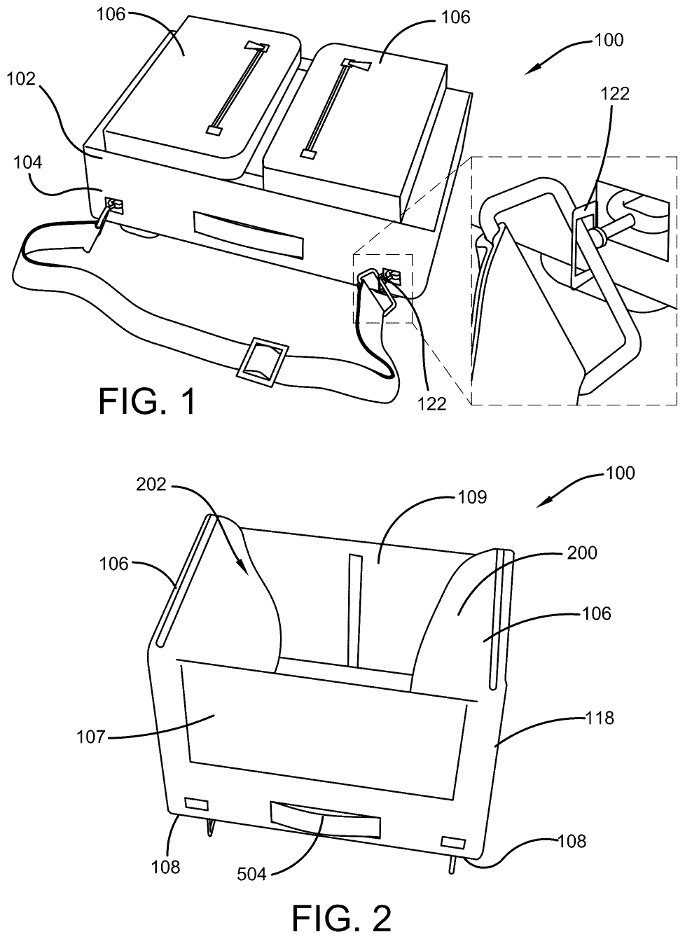

Referring initially to the drawings, FIG. 1 illustrates a perspective view of one embodiment of the pet booster seat device 100 of the present invention. In the present embodiment, the pet booster seat device 100 is an improved pet booster seat device 100 that provides a user with a booster seat for pets. Specifically, the pet booster seat device 100 comprises a base component 102 with a bottom surface 104 and four sides 106. The base component 102 further includes hooks 108 under the bottom surface 104 which unfold and hook to a chair seat 110.

Generally, the pet booster seat device 100 provides users with a booster seat for small animals, such as pets 112. The device 100 allows pet owners to keep their pets 112 close and engage with friends and family in a safe and secure manner. The pet booster seat device 100 is specifically designed for pets 112 to sit on stationary chairs 114, highchairs, barstools, benches, etc. Accordingly, the device 100 offers a way for pet owners to keep their pets 112 elevated, such that they can become part of a group when at different social gatherings.

Further, the pet booster seat device 100 comprises a base component 102 that is configured in a rectangular shape or any other suitable shape as is known in the art. The base component 102 includes a bottom surface 104 and four sides 106 which collapse down flat for storage. Then when in use, the four sides 106 are extended up to form a box-like structure with an open interior cavity 116 for retaining the small pet 112. Typically, the bottom surface 104 and four sides 106 include built-in lightweight rods and connectors 118 along the edges to hold the structure upright during use. Specifically, the rods and connectors 118 would be positioned on the bottom, back, side, and corner edges of the four sides 106 and act to secure the four sides 106 to the bottom surface 104 and also allow the four sides 106 to fold flat onto the bottom surface 104 and extend up, as needed. Typically, the bottom surface 104 and four sides 106 would comprise a thin material that is sturdy and lightweight, and these rods and connectors 118 would attach to the thin material, pulling it taut to form the shape of the pet booster seat device 100.

Typically, the base component 102 (i.e., bottom surface 104 and four sides 106) would be foldable when not in use. Thus, the device 100 can be compacted down and stored behind or under furniture or can easily be transported in its compacted position when users are traveling and/or going on outings.

Additionally, the base component 102 comprises various straps 120 with adjustable lengths and styles to attach to the different types of chairs 114, benches, or stools. The straps 120 are typically secured to anchor points 122 on the base component 102. Specifically, the bottom of the base component 102 which contacts a chair 114 or stool surface would comprise an anchor point 122 at each corner of the base component 102. Further, the base component 102 can also comprise an anchor point 122 at each side of the base component 102 also or instead of the anchor points 122 at each corner. The straps 120 secure to the anchor points 122 then wrap around the seat 110 of the chair 114 or stool and attach together, securing the device 100 to a top of the chair 114 or stool seat for use.

Furthermore, the pet booster seat device 100 may vary in size, fabric, and design, depending on the type of chair 114 or stool that it is to be secured to and/or depending on a user's wants and/or needs.

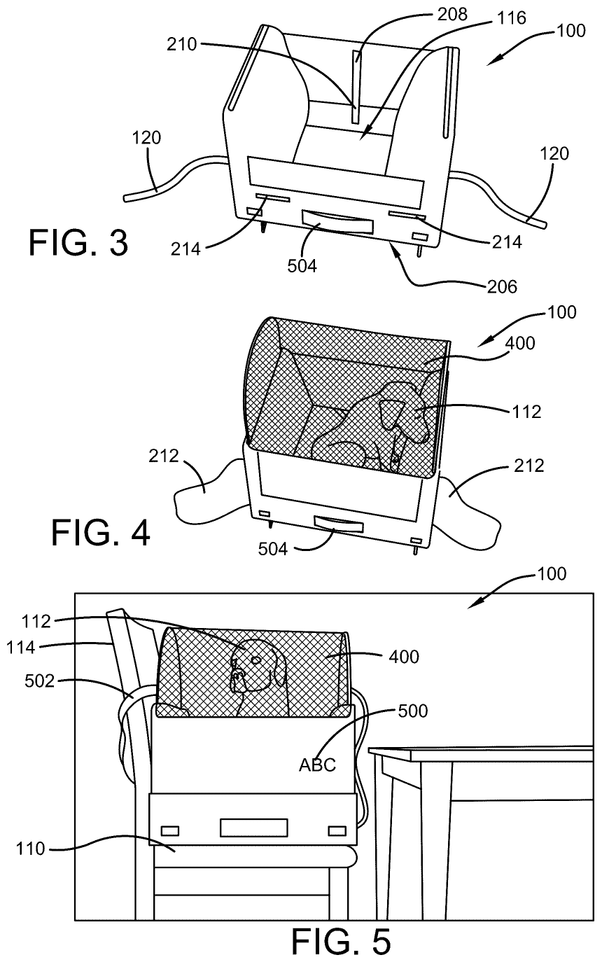

As shown in FIGS. 2-3, the interior surface of the sides 106 and bottom surface 104 comprises cushions or a cushioning layer 200. Overtop the cushioning layer 200 is a cover layer 202 made of a sturdy, flexible, waterproof material which protects the sides 106 and bottom surfaces 104 and is able to be wiped clean, as needed. Further, the side cushions or cushioning layer will be thinner than the bottom surface cushions/cushioning layer, so that it remains foldable for storage and transport.

Further, the front side wall 107 would be lower than the other three side walls 106 during use. Typically, the front side wall 107 can be adjusted, such that it is lowered down or raised up to be level with the other side walls 106. The front side wall 107 can be adjusted up or down via a telescoping mechanism or being folded up or down, etc., or any other suitable adjusting means as is known in the art.

Additionally, the base component 102 further includes hooks 108 under the bottom of the base component 102. The hooks 108 would be secured to an outside edge of the base component 102 and unfold and hook to an outside edge of a chair seat 110 during use. Typically, the hooks 108 fold back against the bottom of the base component 102 with a spring bracket when not in use.

Furthermore, in addition to these hooks 108, there is non-slip material 206 positioned on the bottom of the base component 102 to prevent movement of the device 100 when secured to a chair 114 or stool, to further keep the pet 112 secured and safe during use.

Additionally, at least one of the interior sides 106 of the base component 102 comprises a leash lead 208 built-into the inside. The leash lead 208 includes a leash hook 210 to allow a user to hook to a harness or collar of the pet 112. The leash lead 208 acts to further secure the pet 112 within the device 100 during use and prevent injury.

In one embodiment, the base component 102 comprises zippered pockets 212, one on either side of the base component 102. The zippered pockets 212 are used to store items, such as treats, supplies, and other pet-related items. The zippered pockets 212 can be secured via zippers, hook and loop fasteners, snaps, etc. The zippered pockets 212 can be any suitable shape and size as is known in the art.

In another embodiment, there is one or two zippers 214 (or other fastening means) positioned around a bottom and/or sides of the base component 102 for removing and washing the cover 202, as needed.

As shown in FIG. 4, the base component 102 comprises a mesh top attachment 400 that is secured to the top of the four sides 106, completely enclosing the pet 112 within the open cavity 116 of the device 100. The mesh top attachment 400 can be secured to the four sides 106 via hook and loop fasteners, snaps, zippers, adhesives, etc., or any other suitable securing means as is known in the art. The mesh top attachment 400 protects the pet 112, retains it within the device 100, and allows it to view its surroundings. Thus, the mesh top attachment 400 keeps a pet 112 enclosed within the device 100 on top of comfortable padded cushions positioned on the bottom surface 104, during use.

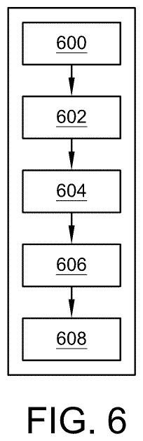

As shown in FIG. 5, the outside of the back side wall 109 or the outside of the back of the base component 102 has a built-in snap strap 502 which secures to a back of the chair 114 or stool. This snap strap 502 would also double as a carrying strap, and a user can place it over their shoulder when the device 100 is folded up for transport. Alternatively or additionally, there could be a carrying handle strap 504 in the front or back of the base component 102 made with thick and durable material for carrying the device 100 during transport.

In one embodiment, optional items can be added to the device 100 for added convenience or aesthetics, such as, but not limited to, water bowls, harnesses, personalized text or logos, etc. Further, the base component 102 can be made of different materials, cushion comforts, designs, patterns, colors, etc.

Further, the pet booster seat device 100 is manufactured from plastics, vinyl, PVC, polyethylene, polystyrene, polypropylene, polyethylene terephthalate, etc., or other suitable materials as is known in the art, or a combination of such materials. Generally, the pet booster seat device 100 is also manufactured from a material that is water resistant or waterproof or comprises a coating that is water resistant or waterproof. Furthermore, the device 100 can be made of antibacterial or antimicrobial material or comprises a coating that is antibacterial or antimicrobial.

In yet another embodiment, the pet booster seat device 100 comprises a plurality of indicia 500. The base component 102 of the device 100 may include advertising, a trademark, or other letters, designs, or characters, printed, painted, stamped, or integrated into the base component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be pet, booster seat, or brand related.

FIG. 6 illustrates a flowchart of the method of securing a pet on a stationary chair. The method includes the steps of at 600, providing a pet booster seat device comprising a base component with a bottom surface and four sides. The method also comprises at 602, securing the base component to a stationary chair via a strap and hooks. Further, the method comprises at 604, extending the sides to form an open cavity for retaining the pet. The method also comprises at 606, positioning a pet within the open cavity and securing the pet with a leash lead. Finally, the method comprises at 608, attaching the mesh top attachment to keep the pet enclosed within the device during use.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet booster seat device”, “booster seat device”, “pet device”, and “device” are interchangeable and refer to the pet booster seat device 100 of the present invention.

Notwithstanding the foregoing, the pet booster seat device 100 of the present invention can be of any suitable size and configuration as is known in the art without affecting the overall concept of the invention, provided that it accomplishes the above-stated objectives. One of ordinary skill in the art will appreciate that the pet booster seat device 100 as shown in FIGS. 1-6 is for illustrative purposes only, and that many other sizes and shapes of the pet booster seat device 100 are well within the scope of the present disclosure. Although the dimensions of the pet booster seat device 100 are important design parameters for user convenience, the pet booster seat device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet booster seat device that provides a user with a booster seat for small animals, the pet booster seat device comprising:
a base component; and
wherein the base component comprises a bottom surface and four sides;
wherein the base component is secured to a chair seat; and
further wherein a pet is secured within the base component, such that it is elevated during social gatherings.

2. The pet booster seat device of claim 1, wherein the base component is configured in a rectangular shape.

3. The pet booster seat device of claim 2, wherein the bottom surface and the four sides which collapse down flat for storage.

4. The pet booster seat device of claim 3, wherein when in use, the four sides are extended up to form a box-like structure with an open interior cavity for retaining the pet.

5. The pet booster seat device of claim 4, wherein the bottom surface and the four sides include built-in lightweight rods and connectors positioned on a bottom, back, side, and corner edges of the four sides and act to secure the four sides to the bottom surface and also allow the four sides to fold flat onto the bottom surface and extend up, as needed.

6. The pet booster seat device of claim 5, wherein the base component comprises various straps secured to anchor points to attach to different types of chairs.

7. The pet booster seat device of claim 6, wherein an interior surface of the four sides and the bottom surface comprise a cushioning layer and a cover layer.

8. The pet booster seat device of claim 7, wherein a front side wall of the four sides would be lower than other three sides and can be adjusted up and down, as needed.

9. The pet booster seat device of claim 8, wherein the base component includes hooks under a bottom of the base component which secure to an outside edge of the base component and unfold and hook to an outside edge of a chair seat during use.

10. The pet booster seat device of claim 9, wherein there is non-slip material positioned on a bottom of the base component to prevent movement of the pet booster seat device when secured to a chair.

11. The pet booster seat device of claim 10, wherein at least one of the four sides of the base component comprises a leash lead with a leash hook to allow a user to hook to a harness or collar of the pet.

12. The pet booster seat device of claim 11, wherein the base component comprises zippered pockets, one on either side of the base component to store items.

13. The pet booster seat device of claim 12, wherein the base component comprises a mesh top attachment that is secured to a top of the four sides, completely enclosing the pet.

14. A pet booster seat device that provides a user with a booster seat for small animals, the pet booster seat device comprising:
a base component configured in a rectangular shape; and
wherein the base component comprises a bottom surface and four sides;
wherein when in use, the four sides are extended up to form a box-like structure with an open interior cavity for retaining the pet;
wherein the bottom surface and the four sides include built-in lightweight rods and connectors positioned on a bottom, back, side, and corner edges of the four sides and act to secure the four sides to the bottom surface and also allow the four sides to fold flat onto the bottom surface and extend up, as needed;
wherein the base component comprises various straps secured to anchor points to attach to different types of chairs;
wherein a front side wall of the four sides would be lower than other three sides and can be adjusted up and down, as needed;
wherein the base component comprises a mesh top attachment that is secured to a top of the four sides, completely enclosing the pet; and
further wherein the pet is secured within the base component, such that it is elevated during social gatherings.

15. The pet booster seat device of claim 14, wherein a back of the base component has a built-in snap strap which secures to a back of the chair.

16. The pet booster seat device of claim 14, wherein the base component includes a carrying handle strap.

17. The pet booster seat device of claim 14, wherein an interior surface of the four sides and the bottom surface comprise a cushioning layer and a cover layer.

18. The pet booster seat device of claim 17, wherein the base component includes one or two zippers for removing and washing the cover layer, as needed.

19. The pet booster seat device of claim 14 further comprising a plurality of indicia.

20. A method of securing a pet on a stationary chair, the method comprising the following steps:
providing a pet booster seat device comprising a base component with a bottom surface and four sides;
securing the base component to a stationary chair via a strap and hooks;
extending the sides to form an open cavity for retaining the pet;
positioning a pet within the open cavity and securing the pet with a leash lead; and
attaching the mesh top attachment to keep the pet enclosed within the device during use.
